(19) United States
(12) Patent Application Publication
(10) Pub. No.: US 2007/0245777 A1
(43) Pub. Date: Oct. 25, 2007

(54) Cable lock

(75) Inventor: Tony Miao, Taishan Hsiang (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Jin Tay Industries Co., Ltd., Taishan Hsiang (TW)

(21) Appl. No.: 11/410,822

(22) Filed: Apr. 25, 2006

(51) Int. Cl. E05B 73/00

(52) U.S. Cl. 70/58

(57) ABSTRACT

A cable lock has a hollow shell, a lock assembly, a cable, a driving wheel and a locking rod. The lock assembly is mounted in the shell and has a lock cylinder and an actuating rod that is allowed to move axially when the lock cylinder is unlocked. The cable is attached to the shell and is fastened to a specific place. The driving wheel is mounted in the shell and has a non-circular central hole. The locking rod has a non-circular head and a threaded rod extends out of the shell. The locking rod is pushed to engage the head and the central hole in the driving wheel. Then rotating the driving wheel screws the threaded rod into an electrical appliance. Therefore, the electrical appliance is securely attached to any specific place with the cable lock.

### BACKGROUND OF THE INVENTION

1. Field of the Invention

The present invention relates to a cable lock, especially to a cable lock that is suitable to attach any electrical appliance to a specific place.

2. Description of the Prior Arts

Open-shelf malls have become more and more common recently. Electrical appliances such as televisions, refrigerators, computers, cell phones, digital cameras, etc. are often displayed at the open-shelf malls to sell. However, security at open-shelf malls is often lax, and merchandise is subject to shoplifting. If the malls do not have sufficient sales personnel or proper security systems to monitor the electrical appliances, the electrical appliances are easily stolen, especially small and expensive electrical appliances such as digital cameras and portable video games. Therefore, the electrical appliances are not safe to sell in open-shelf malls.

To overcome the shortcomings, the present invention provides a cable lock to mitigate or obviate the aforementioned problems.

### SUMMARY OF THE INVENTION

The main objective of the present invention is to provide a cable lock that is suitable to attach any electrical appliance to a specific place. The cable lock has a hollow shell, a lock assembly, a cable, a driving wheel and a locking rod. The lock assembly is mounted in the shell and has a lock cylinder and an actuating rod that is allowed to move axially when the lock cylinder is unlocked. The cable is attached to the shell and is fastened to a specific place. The driving wheel is mounted in the shell and has a non-circular central hole. The locking rod has a non-circular head and a threaded rod extends out of the shell. The locking rod is pushed to engage the head and the central hole in the driving wheel. Then rotating the driving wheel screws the threaded rod into an electrical appliance. Therefore, the electrical appliance is attached to a specific place.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of adapters with a cable lock in accordance with the present invention;

FIG. 2 is an exploded perspective view of the cable lock in FIG. 1;

FIG. 3 is a top view in partial section of the adapter with the cable lock in FIG. 1;

FIG. 4 is an operational top view in partial section of the adapter with the cable lock in FIG. 1;

FIG. 5 is an operational top view in partial section of the adapters with the cable lock in FIG. 1; and

FIG. 6 is an exploded perspective view of an adapter with another embodiment of cable lock in accordance with the present invention.

### DETAILED DESCRIPTION OF THE PREFERRED EMBODIMENTS

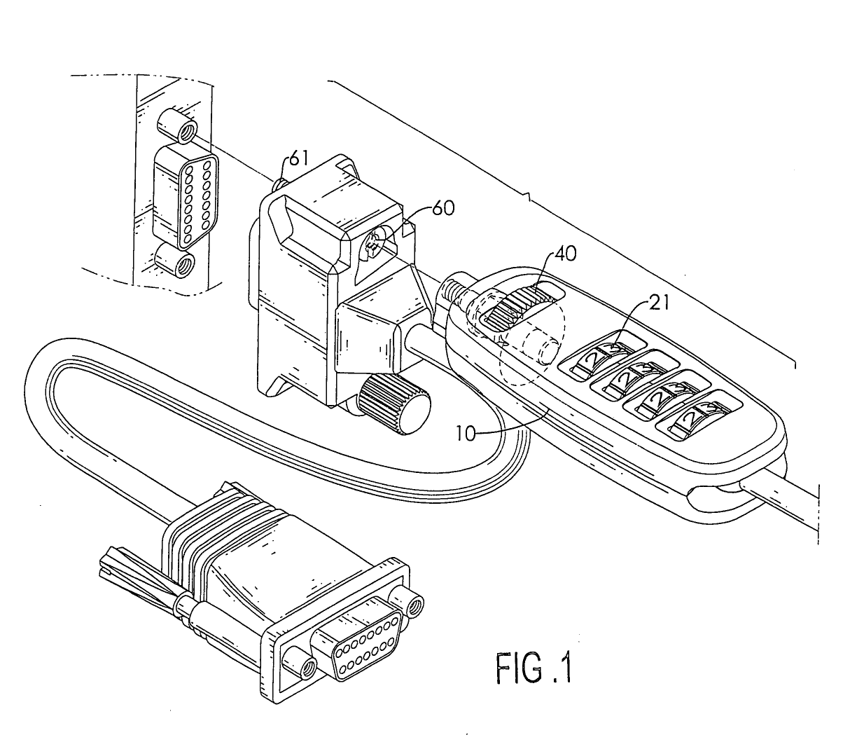

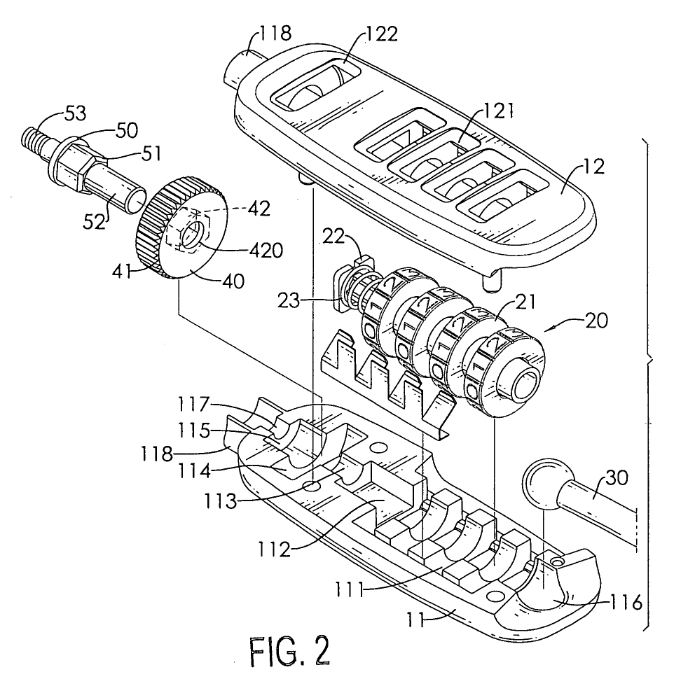

With reference to FIGS. 1 and 2, a cable lock in accordance with the present invention comprises a shell (10), a lock assembly (20), a cable (30), a driving wheel (40) and a locking rod (50).

The shell (10) is hollow, has a rear end and a front end and may have a first cavity (111), a second cavity (112), a third cavity (113), a fourth cavity (114), a fifth cavity (115), a rear opening (116), a front opening (117) and a sleeve (118). The first to fifth cavities (111-115) are formed in the shell (10) in sequence from the rear end to the front end. The rear opening (116) is formed in the rear end. The front opening (117) is formed in the front end. The sleeve (118) is formed on the front end and communicates with the front opening (117). The shell (10) may comprise a base (11) and a cover (12). The cover (12) has multiple locking holes (121) and a through hole (122). The locking holes (121) of the cover (12) correspond to the first cavity (111) in the shell (10). The through hole (122) of the cover (12) corresponds to the fourth cavity (114) in the shell (10).

The lock assembly (20) is mounted in the shell (10) and has a lock cylinder (21), an actuating rod (22) and a spring (23). The lock cylinder (21) is mounted in the shell (10), may be mounted in the first cavity (111) in the shell (10), may extend out of the locking holes (121) of the cover (12) of the shell (10) and may be a combination lock. The actuating rod (22) is mounted in and extends out of the lock cylinder (21) and may extend into the second cavity (112) in the shell (10). The spring (23) is mounted around the actuating rod (22). When the lock cylinder (21) is locked, the actuating rod (22) is held and is unmovable. When the lock cylinder (21) is unlocked, the actuating rod (22) can move axially.

The cable (30) is attached to the shell (10) and may be mounted securely in the rear opening (116) in the shell (10).

The driving wheel (40) is mounted rotatably in and extends transversely out of the shell (10), may be mounted in the fourth cavity (114) in the shell (10), has a front surface, a rear surface, a sidewall and a central hole (42) and may have multiple teeth (41). The central hole (42) corresponds to the actuating rod (22), is non-circular, may be hexagon and may have a circular opening (420) formed in the rear surface of the driving wheel (40). The teeth (41) are formed around the sidewall of the driving wheel (40).

The locking rod (50) is mounted movable in the shell (10), has a head (51), a threaded rod (53) and a circular rod (52). The head (51) is non-circular, may be hexagon, corresponds to and selectively engages the central hole (42) in the driving wheel (40) and has an inside end and an outside end. The threaded rod (53) is formed longitudinally on the outside end of the head (51), extends out of the front end of the shell (10), may extend through the front opening (117) of the shell (10) and may extend into the sleeve (118) of the shell (10). The threaded rod (53) has a diameter smaller than that of the sleeve (118) of the shell (10). The circular rod (52) is formed coaxially on the inside end of the head (51), extends through the central hole (42) of the driving wheel (40) and abuts the actuating rod (22) of the lock assembly (20).

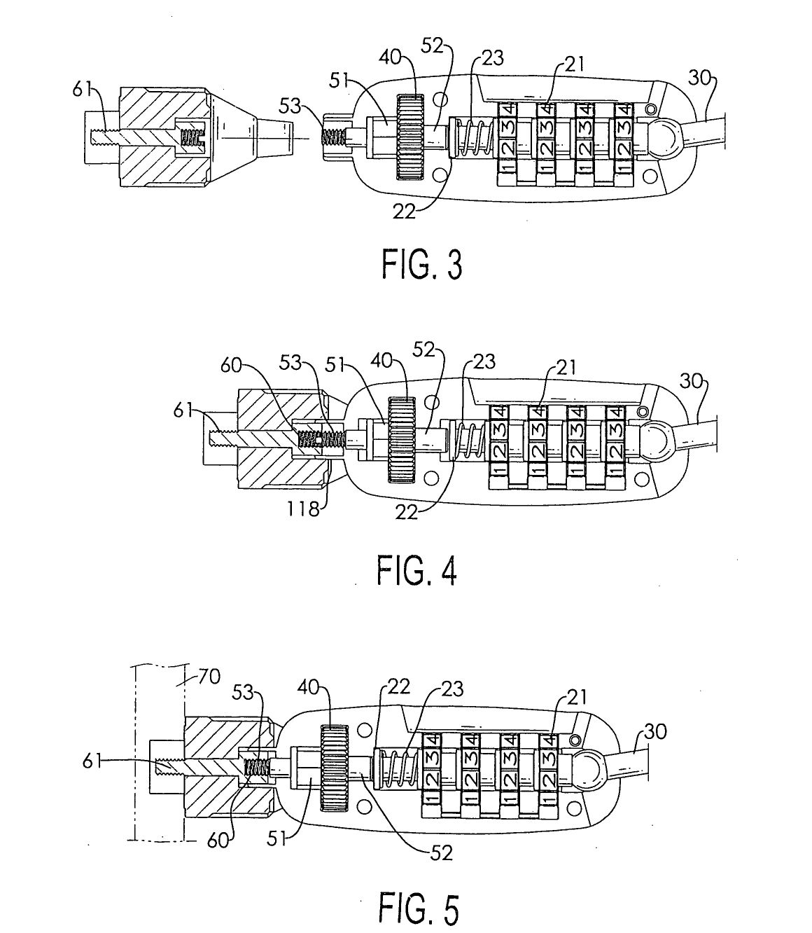

With further reference to FIG. 3, when the lock cylinder (21) is locked, the lock cylinder (21) keeps the actuating rod (22) from moving axially. The actuating rod (22) stops the locking rod (50) moving relative to the driving wheel (40). The spring (23) pushes the actuating rod (22) to push the head (51) to disengage the central hole (42) in the driving wheel (40). Therefore, the driving wheel (40) cannot rotate the locking rod (50) and will rotate freely relative to the locking rod (50).

With further reference to FIGS. 4 and 5, when the lock cylinder (21) is unlocked, the actuating rod (22) can be moved axially. When the threaded rod (53) of the locking rod (50) abuts a threaded hole (60) in an adapter, the locking rod (50) is pushed to move inwardly and the circular rod (52) pushes the actuating rod (22) to press the spring (23). Then the head (51) engages the central hole (42) in the driving wheel (40). When the user rotates the driving wheel (40), the driving wheel (40) rotates the locking rod (50) to screw the threaded rod (53) into the threaded hole (60). The screw (61) of the adapter can also be screwed into the electrical appliance (70) to fasten the cable lock of the present invention and the electrical appliance (70).

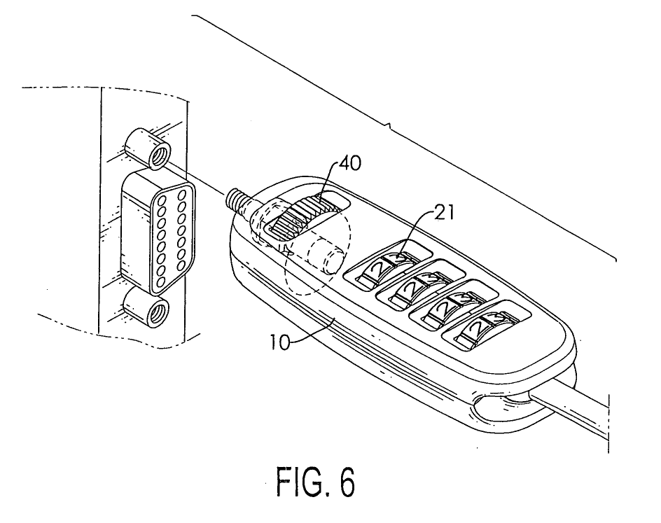

With further reference to FIG. 6, the cable lock of the present invention can also be screwed into a threaded hole on an adapter of the electrical appliance directly. Therefore, to define an additional threaded hole at a specific position for attaching the cable lock on an electrical appliance is unnecessary, such that to connect the cable lock onto an electrical appliance is convenient. Thus, the cable lock of the present invention can securely attach any electrical appliance to a specific place.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. A cable lock comprising:
a hollow shell having a rear end and a front end;
a lock assembly mounted in the shell and having a lock cylinder mounted in the shell;
an actuating rod mounted in and extending out of the lock cylinder, wherein when the lock cylinder is locked, the actuating rod is held and is unmovable and when the lock cylinder is unlocked, the actuating rod can move axially; and
a spring mounted around the actuating rod;
a cable attached to the shell;
a driving wheel mounted rotatably in an extending transversely out of the shell and having
a front surface;
a rear surface;
a sidewall; and
a non-circular central hole corresponding to the actuating rod; and
a locking rod mounted movable in the shell, aligning with the actuating rod of the lock assembly and having
a non-circular head corresponding to and selectively engaging with the central hole in the driving wheel and having an inside end and an outside end;
a threaded rod formed longitudinally on the outside of the head and extending out of the front end of the shell; and
a circular rod formed longitudinally on the inside end of the head, extending through the central hole of the driving wheel and abutting with the actuating rod of the lock assembly.

2. The cable lock as claimed in claim 1, wherein
the shell has a sleeve formed on the front end of the shell; and
the threaded rod of the locking rod extends into the sleeve of the shell.

3. The cable lock as claimed in claim 1, wherein
the shell comprises the cover and a base and has
a first cavity formed in the shell adjacent to the rear end of the shell;
a second cavity formed in the shell adjacent to the first cavity;
a third cavity formed in the shell adjacent to the second cavity;
a fourth cavity formed in the shell adjacent to the third cavity;
a fifth cavity formed in the shell between the fourth cavity and the front end of the shell;
a rear opening formed in the rear end of the shell;
a front opening formed in the front end of the shell;
multiple locking holes corresponding to the first cavity in the shell; and
a through hole corresponding to the fourth cavity in the shell;
the lock cylinder is mounted in the first cavity in the shell and extends out of the locking holes of the cover of the shell;
the actuating rod extends into the second cavity in the shell;
the cable is mounted securely in the rear opening in the shell;
the driving wheel is mounted in the fourth cavity in the shell; and
the threaded rod of the locking rod extend through the front opening of the shell.

4. The cable lock as claimed in claim 2, wherein
the shell comprises a cover and a base and has
a first cavity formed in the shell adjacent to the rear end of the shell;
a second cavity formed in the shell adjacent to the first cavity;
a third cavity formed in the shell adjacent to the second cavity;
a fourth cavity formed in the shell adjacent to the third cavity;
a fifth cavity formed in the shell between the fourth cavity and the front end of the shell;
a rear opening formed in the rear end of the shell;
a front opening formed in the front end of the shell and communicating with the sleeve of the shell;
multiple locking holes corresponding to the first cavity in the shell; and a through hole corresponding to the fourth cavity in the shell;
the lock cylinder is mounted in the first cavity in the shell and extends out of the locking holes of the cover of the shell;
the actuating rod extends into the second cavity in the shell;
the cable is mounted securely in the rear opening in the shell;
the driving wheel is mounted in the fourth cavity in the shell; and
the threaded rod of the locking rod extend through the front opening of the shell.

5. The cable lock as claimed in claim 1, wherein the central hole of the driving wheel has a circular opening formed in the rear surface of the driving wheel.

6. The cable lock as claimed in claim 4, wherein the central hole of the driving wheel has a circular opening formed in the rear surface of the driving wheel.

7. The cable lock as claimed in claim 1, wherein
the central hole in the driving wheel is hexagon; and
the head of the locking rod is hexagon.

8. The cable lock as claimed in claim 6, wherein
the central hole in the driving wheel is hexagon; and
the head of the locking rod is hexagon.

9. The cable lock as claimed in claim 1, wherein
the driving wheel has multiple teeth formed around the sidewall of the driving wheel.

10. The cable lock as claimed in claim 1, wherein
the lock cylinder is a combination lock.
